(19) United States
(12) Patent Application Publication
(10) Pub. No.: US 2011/0228726 A1
(43) Pub. Date: Sep. 22, 2011

(54) METHOD OF CONFIGURING MULTI-LEVEL PACKET TRANSMISSION PATHS IN A WIRELESS SENSOR NETWORK

(75) Inventors: Ting-Yi Chen, Hsinchu (TW); Chung-Ta King, Hsinchu (TW)

(73) Assignee: National Tsing Hua University, Hsinchu (TW)

(21) Appl. No.: 13/049,636

(22) Filed: Mar. 16, 2011

(30) Foreign Application Priority Data
Mar. 17, 2010 (TW) 099107759

(51) Int. Cl. H04W 4/00

(52) U.S. Cl. 370/328

(57) ABSTRACT

A method of configuring multi-level packet transmission paths in a wireless sensor network includes an initial configuration procedure and an optimization procedure. The wireless sensor network includes a plurality of sensor units and a processing unit that configures the multi-level packet transmission paths among the sensor units for transmitting a to-be-transmitted packet group. The initial configuration procedure configures the packet transmission paths among the sensor units for transmitting the to-be-transmitted packet group which includes a plurality of packets under a condition that a number of the sensor units is not increased. The optimization procedure adjusts the packet transmission paths, resulting from the initial configuration procedure, among the sensor units for transmission of a portion of packets in the to-be-transmitted packet group so as to reduce the number of the sensor units.

### CROSS-REFERENCE TO RELATED APPLICATION

This application claims priority of Taiwanese Application No. 099107759, filed on Mar. 17, 2010.

### BACKGROUND OF THE INVENTION

1. Field of the Invention

The present invention relates to a method of configuring a wireless sensor network, more particularly to a method of configuring multi-level packet transmission paths in a wireless sensor network.

2. Description of the Related Art

Wireless sensor networks are widely used for monitoring multiple environmental parameters in the field. Such wireless sensor networks for monitoring environmental parameters have a network architecture that each of to-be-monitored positions is provided with a corresponding sensor. Each of the sensors transmits data of monitored environmental parameters periodically to a data center.

The data of environmental parameters usually need to be collected during a relatively long period of time for observing variations in these environmental parameters. However, electric power of each sensor is limited. Currently, a plurality of spare sensors need to be provided in a same to-be-monitored position for monitoring environmental parameters consistently. Therefore, a number of the sensors required in each of the to-be-monitored positions must be calculated in advance according to required data volume prior to deploying a wireless sensor network. Moreover, the number of the sensors has a large influence on the cost of the wireless sensor network. Thus, how to use fewer numbers of sensors to achieve an object of collecting environmental parameters so as to reduce the cost of the wireless sensor network is important topic in the relevant field.

### SUMMARY OF THE INVENTION

Therefore, an object of the present invention is to provide a method of configuring multi-level packet transmission paths in a wireless sensor network.

Accordingly, the wireless sensor network includes a plurality of sensor units and a processing unit that configures the multi-level packet transmission paths among the sensor units for transmitting a to-be-transmitted packet group. The method of the present invention includes:

a) configuring the processing unit to determine a transmittable packet number of each of the sensor units; and

b) configuring packet transmission from one of the sensor units disposed in a higher level of the packet transmission paths to the sensor units which are coupled to said one of the sensor units in the higher level and which are disposed in a next lower level relative to the higher level, including

b1) configuring the processing unit to make a first determination to determine if the transmittable packet number of one of the sensor units, that is disposed in the next lower level, that is coupled to said one of the sensor units in the higher level, and that has a largest transmittable packet number relative to other ones of the sensor units which are in the next lower level and which are coupled to said one of the sensor units in the higher level, is greater than a number of packets in the to-be-transmitted packet group that are to be transmitted by said one of the sensor units in the higher level to the next lower level,

b2) if result of the first determination is affirmative, configuring the processing unit to set said one of the sensor units in the next lower level for transmission of all of the packets in the to-be-transmitted packet group, and

b3) if the result of the first determination is negative,
b31) configuring the processing unit to set said one of the sensor units in the next lower level for transmission of a portion of the packets in the to-be-transmitted packet group, and
b32) configuring the processing unit to calculate a remaining number of packets in the to-be-transmitted packet group, to update the number of packets in the to-be-transmitted packet group using the remaining number thus calculated, and to adjust the transmittable packet number of said one of said sensor units set in sub-step b31) to zero.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart illustrating an initial configuration procedure of a method of configuring multi-level packet transmission paths in a wireless sensor network of the present invention;

FIG. 2 is a schematic diagram illustrating determination of a transmittable packet number of each of sensor units in the wireless sensor network;

FIG. 3 is a schematic diagram illustrating the packet transmission paths before applying adjustments of an optimization procedure of the method of the preferred embodiment;

FIG. 4 is a schematic diagram illustrating the packet transmission paths after applying the adjustments of the optimization procedure of the method of the preferred embodiment; and

FIG. 5 is a flowchart illustrating the optimization procedure of the method of configuring multi-level packet transmission paths in the wireless sensor network of the present invention.

### DETAILED DESCRIPTION OF THE PREFERRED EMBODIMENT

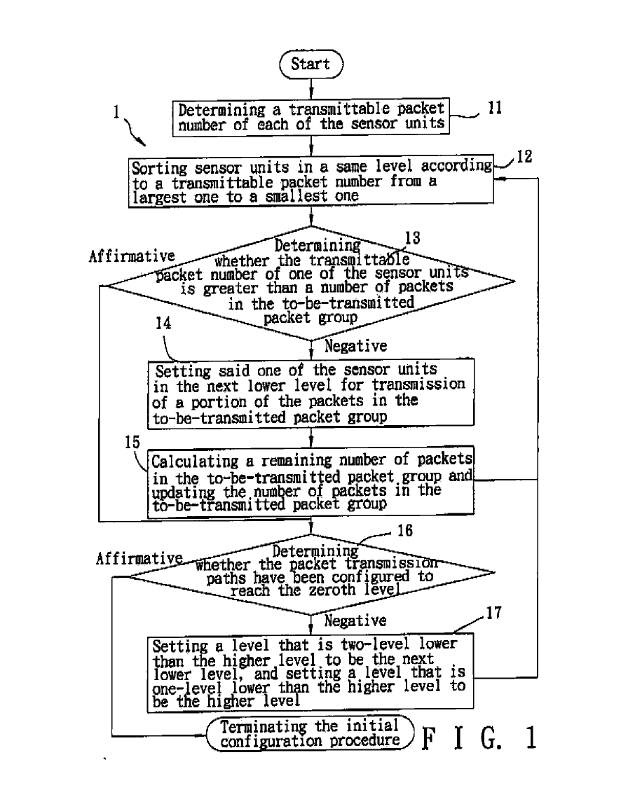

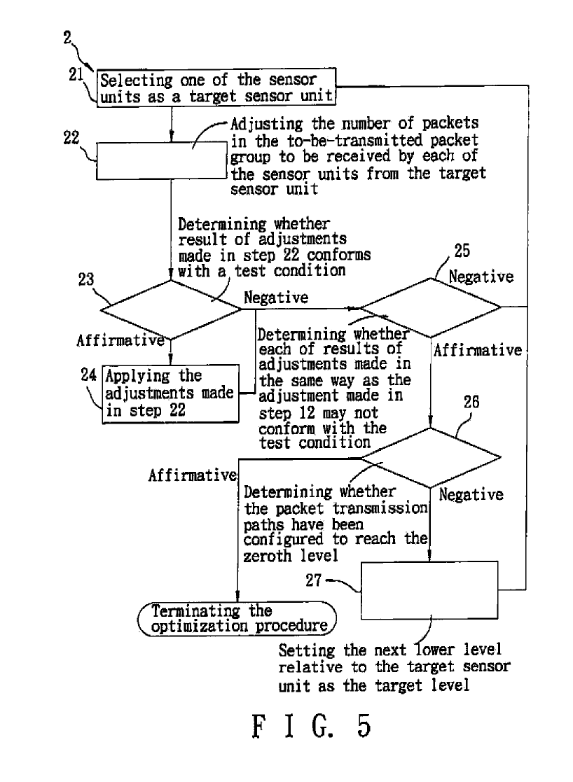

Referring to FIG. 1 and FIG. 5, the preferred embodiment of a method of configuring multi-level packet transmission paths in a wireless sensor network according to this invention includes an initial configuration procedure 1 and an optimization procedure 2. The wireless sensor network includes a plurality of sensor units and a processing unit that configures the multi-level packet transmission paths among the sensor units for transmitting a to-be-transmitted packet group.

The initial configuration procedure 1 configures the packet transmission paths among the sensor units for transmitting the to-be-transmitted packet group which includes a plurality of packets under a condition that a number of the sensor units is not increased. The optimization procedure 2 adjusts the packet transmission paths, resulting from the initial configuration procedure 1, among the sensor units for transmission of a portion of packets in the to-be-transmitted packet group so as to reduce the number of the sensor units.

The initial configuration procedure 1 is illustrated hereinafter.

Referring once again to FIG. 1, in step 11 of the initial configuration procedure 1, the processing unit is configured to determine a transmittable packet number addBW (u, hop_{guess}) of each of the sensor units according to the following equation:

$$addBW ( u , {hop}_{guess} ) = [ \begin{matrix}min \{ q ( u ) , \sum addBW ( {v}_{i} , {hop}_{guess} - 1 \} & if {hop}_{guess} \geq 1 \\ q ( u ) , & if {hop}_{guess} = 0\end{matrix}$$

in which u represents a sensor unit, hop_{guess} represents a level of the packet transmission paths in which the sensor unit u is disposed, addBW (u, hop_{guess}) represents a transmittable packet number of the sensor unit u configured according to packet transmission capabilities of sensor units that are in a next lower level hop_{guess}−1 relative to the sensor unit u and that are coupled to the sensor unit u, q(u) represents the transmittable packet number of the sensor unit u without considering other sensor units, and vᵢ, represents a sensor unit that is in the next lower level hop_{guess}−1 and that is coupled to the sensor unit u.

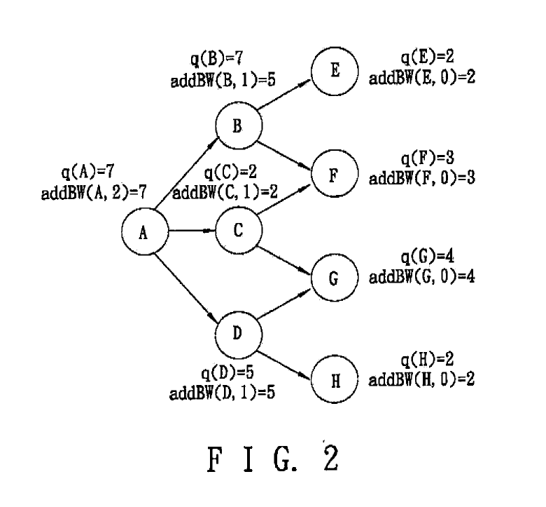

For example, referring to FIG. 2, a wireless sensor network includes seven sensor units A to H, in which, the sensor units E, F, G, H are disposed in a zeroth level (i.e., hop_{guess}=0), the sensor units B, C, D are disposed in a first level (i.e., hop_{guess}=1), and the sensor unit A is disposed in a second level (i.e., hop_{guess}−2). Observing packet transmission paths from the sensor unit B in the first level to the sensor units E, F in the zeroth level, although the sensor unit B has a capability of transmitting seven packets (i.e., q(B)=7), a transmittable packet number of the sensor unit B in the first level is determined to be 5 (i.e., addBW(B,1)=5) because a sum of transmittable packet numbers of the sensor units E, F in the zeroth level is merely 5. Furthermore, observing packet transmission paths from the sensor unit C in the first level to the sensor units F, G in the zeroth level, even though a sum of transmittable packet numbers of the sensor units F, G in the zeroth level relative to the first level in which the sensor unit C is disposed is 7, a transmittable packet number of the sensor unit C in the first level is determined to be 2 (i.e., addBW(C,1)=2) because the sensor unit C has a capability of transmitting only two packets (i.e., q(C)=2). The transmittable packet numbers of the other sensor units may be deduced by analogy.

Referring to FIG. 1 and FIG. 2, packet transmission from one of the sensor units disposed in a higher level of the packet transmission paths to the sensor units which are coupled to said one of the sensor units in the higher level and which are disposed in a next lower level relative to the higher level is configured according to the following steps.

In step 12 of the initial configuration procedure 1, the processing unit is configured to sort sensor units in a same level according to a transmittable packet number of each of the sensor units in the same level from a largest one to a smallest one so as to obtain a sorting result. Referring to FIG. 2, for example, the sorting result of the first level is B-D-C (or D-B-C), and the sorting result of the zeroth level is G-F-E-H (or G-F-H-E).

Referring to FIG. 1 and FIG. 2, in step 13 of the initial configuration procedure 1, the processing unit is configured to make a first determination to determine according to the sorting result obtained in step 12 if the transmittable packet number of one of the sensor units (such as the sensor unit B in FIG. 2), that is disposed in the next lower level (i.e., the first level), that is coupled to said one of the sensor units in the higher level (i.e., sensor unit A in the second level), and that has a largest transmittable packet number relative to other ones of the sensor units (i.e., sensor units C and D) which are in the next lower level and which are coupled to said one of the sensor units in the higher level, is greater than a number of packets in the to-be-transmitted packet group that are to be transmitted by said one of the sensor units in the higher level to the next lower level. If result of the first determination is affirmative, the processing unit is configured to set said one of the sensor units in the next lower level for transmission of all of the packets in the to-be-transmitted packet group and step 16 is performed. If the result of the first determination is negative, step 14 is performed.

Referring to FIG. 1 and FIG. 2, in step 14 of the initial configuration procedure 1, the processing unit is configured to set said one of the sensor units in the next lower level for transmission of a portion of the packets in the to-be-transmitted packet group. For example, referring to FIG. 2, supposing the number of packets in the to-be-transmitted packet group to be transmitted by the sensor unit A in the second level to the first lower level is six, the processing unit sets the sensor unit B for transmission of five packets in the to-be-transmitted packet group. The flow then proceeds to step 15.

Referring to FIG. 1 and FIG. 2, in step 15 of the initial configuration procedure 1, the processing unit is configured to calculate a remaining number of packets in the to-be-transmitted packet group, to update the number of packets in the to-be-transmitted packet group using the remaining number thus calculated, to adjust the transmittable packet number of said one of said sensor units set in step 14 to zero, and to repeat step 12. For example, referring to FIG. 2, after the sensor unit B has been set for transmission of five packets in the to-be-transmitted packet group, the processing unit calculates the remaining number of packets in the to-be-transmitted packet group to be one, updates the number of packets in the to-be-transmitted packet group to one, adjusts the transmittable packet number of the sensor unit B to zero (i.e., addBW(B,1)=0), and repeats step 12.

Referring to FIG. 1 and FIG. 2, in step 16 of the initial configuration procedure 1, the processing unit is configured to terminate the initial configuration procedure 1 upon determining that the packet transmission paths have been configured to reach the zeroth level. Otherwise, step 17 is performed.

Referring to FIG. 1 and FIG. 2, in step 17 of the initial configuration procedure 1, the processing unit is configured to set a level that is two levels lower than the higher level to be the next lower level, to set a level that is one level lower than the higher level to be the higher level, and to repeat step 12.

Specifically, the example in step 15 may be further explained hereinafter. When step 12 is performed once again, since the transmittable packet number of the sensor unit B has been set to zero, the sorting result of the first level is D-C-B. Moreover, in step 13, the sensor unit D is set for transmission of the remaining one packet in the to-be-transmitted packet group. In step 17, the packet transmission paths from the first level to the zeroth level are ready to be configured. Finally, the packet transmission paths are configured as A-B-E (transmission of two packets in the to-be-transmitted packet group of the sensor unit A), A-B-F (transmission of three packets in the to-be-transmitted packet group of the sensor unit A), and A-D-G (transmission of one packet in the to-be-transmitted packet group of the sensor unit A).

Before illustrating the optimization procedure 2, an example of configuration of the optimization procedure 2 is provided hereinafter.

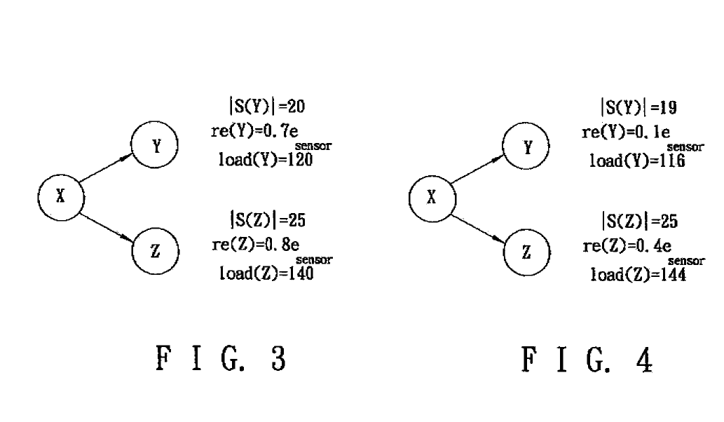

Referring to FIG. 3 and FIG. 4, three sensor unit groups X, Y, Z are illustrated. The sensor unit group X is coupled to the sensor unit group Y and the sensor unit group Z for transmission of packets thereto, respectively. Each of the sensor unit groups X, Y, Z includes a plurality of sensor units. Each of |S(Y)| and |S(Z)| represents a number of the sensor units in a respective one of the sensor unit groups Y and Z. Each of load(Y) and load(Z) represents a number of packets transmitted from the sensor unit group X to a respective one of the sensor unit groups Y and Z. Furthermore, each of re(Y) and re(Z) represents a sum of remaining electric power of all the sensor units in a respective one of the sensor unit groups Y and Z. Finally, eₛₑₙₛₒᵣ represents a unit power of a sensor unit.

The sensor unit group Y may save deployment of one sensor unit (i.e., |S(Y)| is reduced from 20 to 19) when the sensor unit group X adjusts transmission of four packets, which are originally to be transmitted to the sensor unit group Y, to the sensor unit group Z such that one of the sensor units in the sensor unit group Y is redundant. Moreover, none of the remaining electric power of each of the sensor units in the sensor unit group Z is smaller than zero after the adjustment. In other words, the number of the sensor units in the sensor unit group Z is not increased (i.e., |S(Z)| remains 25). In this way, by adjusting transmission of the four packets, which are originally to be transmitted to the sensor unit group Y, to the sensor unit group Z, a number of the sensor units in the whole wireless sensor network may be saved, and waste of the remaining electric power may be reduced (a total of the remaining electric power of all the sensor units in the sensor unit groups Y and Z is reduced from 1.5 eₛₑₙₛₒᵣ to 0.5 eₛₑₙₛₒᵣ after the adjustment). Therefore, referring to FIG. 1 and FIG. 5, the optimization procedure 2 optimizes the configuration of the packet transmission paths derived from the initial configuration procedure 1 based on effective usage of the remaining electric power of each of the sensor units, such that the total number of the sensor units in the whole wireless sensor network may be reduced for achieving an object of reducing the cost of deployment of the wireless sensor network.

Referring to FIG. 5, in step 21 of the optimization procedure 2, the processing unit is configured to select one of the sensor units as a target sensor unit in a target level. The target sensor unit is selected according to the following inequality:

$$eliminate BW ( {v}_{k} , {hop}_{guess} ) \leq {\sum }_{j = l and j \neq k}^{″} addBW ( {v}_{j} , {hop}_{guess} )$$

in which, vₖ represents the target sensor unit, hop_{guess} represents a level of the packet transmission paths in which the target sensor unit vₖ is disposed (i.e./the target level), vⱼ represents another sensor unit in the same level as the target sensor unit vₖ, eliminateBW (vₖ, hop_{guess}) represents the number of packets having transmission paths that may be adjusted under a condition that power requirement of other sensor units is not increased, and addBW (vᵢ, hop_{guess}) represents a transmittable packet number of the sensor unit vⱼ configured according to packet transmission capabilities of sensor units that are in the next lower level relative to the sensor unit vⱼ and that are coupled to the sensor unit vⱼ. Furthermore, eliminateBW (vₖ, hop_{guess}) satisfies the following equation:

$$eliminateBW ( u , {hop}_{guess} ) = \{ \begin{matrix}max [ eq ( u ) , min ( eliminateBW ( {v}_{i} , {hop}_{guess} - 1 ) ) ] , & {hop}_{guess} \geq 1 \\ eq ( u ) , & {hop}_{guess} = 0\end{matrix}$$

in which, eq(u) represents the number of packets whose transmission paths that need to be adjusted by the processing unit under a condition that one sensor unit may be saved from a sensor unit group u.

In step 22 of the optimization procedure 2, the processing unit is configured to adjust the number of packets in the to-be-transmitted packet group to be received by each of the sensor units, which are in the next lower level relative to the target sensor unit and which are coupled to the target sensor unit, from the target sensor unit.

In step 23 of the optimization procedure 2, the processing unit is configured to make a second determination to determine whether result of adjustments made in step 22 conforms with a test condition. The test condition is that a total number of the sensor units in the wireless sensor network can be reduced.

In step 24 of the optimization procedure 2, if the result of the second determination is affirmative, the processing unit is configured to apply the adjustments made in step 22.

In step 25 of the optimization procedure 2, the processing unit is configured to make a third determination to determine whether each of results of adjustments made in the same way as the adjustment made in step 22 may not conform with the test condition when a respective one of the sensor units in the target level is selected as the target sensor unit. If result of the third determination is affirmative, step 26 is performed. If the result of the third determination is negative, the processing unit repeats step 21 so as to select another sensor unit in the same level (i.e., the target level) which the target sensor unit is disposed as the new target sensor unit.

In step 26 of the optimization procedure 2, the processing unit is configured to terminate the optimization procedure 2 upon determining that the packet transmission paths have been configured to reach the zeroth level. Otherwise, step 27 of the optimization procedure 2 is performed.

In step 27, the processing unit is configured to set the next lower level relative to the target sensor unit as the target level, and to repeat step 21.

In summary, packet transmission paths in a wireless sensor network are configured without increasing the cost of deployment of the wireless sensor network (i.e., without increasing the number of the sensor units) after the initial configuration procedure 1. Moreover, the packet transmission paths configured from the initial configuration procedure 1 are adjusted through the optimization procedure 2 so as to save the number of the sensor units for further reducing the cost of deployment of the wireless sensor network.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of configuring multi-level packet transmission paths in a wireless sensor network, the wireless sensor network including a plurality of sensor units and a processing unit that configures the multi-level packet transmission paths among the sensor units for transmitting a to-be-transmitted packet group, the method comprising:
a) configuring the processing unit to determine a transmittable packet number of each of the sensor units; and
b) configuring packet transmission from one of the sensor units disposed in a higher level of the packet transmission paths to the sensor units which are coupled to said one of the sensor units in the higher level and which are disposed in a next lower level relative to the higher level, including
b1) configuring the processing unit to make a first determination to determine if the transmittable packet number of one of the sensor units, that is disposed in the next lower level, that is coupled to said one of the sensor units in the higher level, and that has a largest transmittable packet number relative to other ones of the sensor units which are in the next lower level and which are coupled to said one of the sensor units in the higher level, is greater than a number of packets in the to-be-transmitted packet group that are to be transmitted by said one of the sensor units in the higher level to the next lower level,
b2) if result of the first determination is affirmative, configuring the processing unit to set said one of the sensor units in the next lower level for transmission of all of the packets in the to-be-transmitted packet group, and
b3) if the result of the first determination is negative,
b31) configuring the processing unit to set said one of the sensor units in the next lower level for transmission of a portion of the packets in the to-be-transmitted packet group, and
b32) configuring the processing unit to calculate a remaining number of packets in the to-be-transmitted packet group, to update the number of packets in the to-be-transmitted packet group using the remaining number thus calculated, and to adjust the transmittable packet number of said one of said sensor units set in sub-step b31) to zero.

2. The method as claimed in claim 1, wherein, in step a), the transmittable packet number of each of the sensor units is determined according to the following equation:
$$addBW ( u , {hop}_{guess} ) = \{ \begin{matrix}min \{ q ( u ) , \sum ( addBE ( {v}_{i} , {hop}_{guess} - 1 ) \} , & if {hop}_{guess} \geq 1 \\ q ( u ) , & if {hop}_{guess} = 0\end{matrix}$$
in which, u represents a sensor unit, hop_{guess} represents a level of the packet transmission paths in which the sensor unit u is disposed, addBW (u, hop_{guess}) represents a transmittable packet number of the sensor unit u configured according to packet transmission capabilities of sensor units that are in the next lower level relative to the sensor unit u and that are coupled to the sensor unit u, q(u) represents the transmittable packet number of the sensor unit u without considering other sensor units, and v, represents a sensor unit that is in the next lower level hop_{guess}−1 and that is coupled to the sensor unit u.

3. The method as claimed in claim 1, further comprising:
c) configuring the processing unit to select one of the sensor units as a target sensor unit, and to adjust the number of packets in the to-be-transmitted packet group to be received by each of the sensor units, which are in the next lower level relative to the target sensor unit and which are coupled to the target sensor unit, from the target sensor unit;
d) configuring the processing unit to make a second determination to determine whether result of adjustments made in step c) conforms with a test condition;
e) if the result of the second determination is affirmative, configuring the processing unit to apply the adjustments made in step c); and
f) if the result of the second determination is negative, or after the processing unit is configured in step e) to apply the adjustments made in step c), repeating steps c) to f) using another one of the sensor units as the target sensor unit.

4. The method as claimed in claim 3, wherein the test condition is that a total number of the sensor units in the wireless sensor network can be reduced.

5. The configuration method as claimed in claim 3, wherein the target sensor unit is selected according to the following inequality:
$$eliminateBW ( {v}_{k} , {hop}_{guess} ) \leq {\sum }_{j = l and j \neq k}^{″} addBW ( {v}_{j} , {hop}_{guess} )$$
in which, vₖ represents the target sensor unit, hop_{guess} represents a level of the packet transmission paths in which the target sensor unit vₖ is disposed, vⱼ represents another sensor unit in the same level as the target sensor unit vₖ, eliminateBW (vₖ, hop_{guess}) represents the number of packets having transmission paths that may be adjusted under a condition that power requirement of other sensor units is not increased, and addBW (vᵢ, hop_{guess}) represents a transmittable packet number of the sensor unit vⱼ configured according to packet transmission capabilities of sensor units that are in the next lower level relative to the sensor unit vⱼ and that are coupled to the sensor unit vⱼ.
